(19) United States
(12) Patent Application Publication
(10) Pub. No.: US 2007/0242299 A1
(43) Pub. Date: Oct. 18, 2007

(54) Document management apparatus, document management method and document management program

(75) Inventors: Minako Kobayashi, Osaka (JP); Takeshi Morikawa, Takarazuka-shi (JP); Nobuo Kamei, Amagasaki-shi (JP); Kei Shigehisa, Amagasaki-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/581,371

(22) Filed: Oct. 17, 2006

(30) Foreign Application Priority Data
Apr. 13, 2006 (JP) 2006-110720

(51) Int. Cl. G06F 3/12

(52) U.S. Cl. 358/1.13; 358/448

(57) ABSTRACT

A document management apparatus 101 that manages saving of an original electronic document and an additional electronic document to which additional information is added to the original electronic document includes an original registration unit 10131 that acquires the additional electronic document inputted by a user, and a saving format determination unit 10133 that determines a saving format of the additional electronic document based on at least one of an attribute of the user and an attribute of the additional electronic document, and saves the additional electronic document in the determined saving format.

### CROSS-REFERENCE TO RELATED APPLICATION

This application is based on application No. 2006-110720 filed in Japan, the contents of which are hereby incorporated by reference.

### BACKGROUND OF THE INVENTION

(1) Field of the Invention

The present invention relates to a document management technique for managing an electronic document accessible by a plurality of users. The present invention particularly relates to a document management technique, in the case where a content of an original electronic document is partly changed due to edition, etc., for managing the original electronic document and its partly changed electronic document.

(2) Description of the Related Art

In recent years, document electronization has been progressing, and therefore paperless offices also have been increasing rapidly.

Documents that have been conventionally treated in paper form in offices now have become electronic documents by being created with personal computers or being read with scanners, and are stored and managed in a data base.

Accordingly, a user has no need to store various kinds of information in paper form, and can read an electronic document from the data base when needed, and then output the electronic document in paper form.

Also, if a user additionally writes to an outputted paper document, the outputted paper document is read by a scanner, converted into an additional electronic document, and stored in a server so that the additional electronic document can be searched from the server. Here, “additional electronic document” indicates image data of a paper document that includes information written to an original paper document and information additionally written to the original paper document. Such art is disclosed in Japan Patent Application Publication No. 2005-149097.

Specifically, if the user additionally writes to a hard copy of image data of an original document by handwriting, etc., differential information between image data of the original document and image data of the original document after additional writing is extracted using the image processing system. And then, the extracted differential information and the image data of the original document are separately saved in correspondence with each other.

Accordingly, image data of the additional electronic document can be easily reproduced using the differential information and image data of the original document so as to be outputted, without overwriting the original electronic document.

Also, the additional electronic document can be saved in an overwrite-saving format for overwriting the original electronic document with the additional electronic document and saving the additional electronic document, or in a separately-saving format for saving the original electronic document separately from the additional electronic document.

However, in the conventional art, the original electronic document can be overwritten in irrelevant to the user's authority. Therefore, a document to which only a user having a specific authority such as a manager can additionally write and overwrite (for example, an approval document) is additionally written and is overwritten by an unauthorized user. This causes a trouble.

Therefore, it is desirable that saving attribute information that indicates a saving format of an original electronic document is added to the original electronic document, and a saving format is determined based on the added saving attribute information.

### SUMMARY OF THE INVENTION

In view of the above problem, the present invention aims to provide a document management apparatus, a document management method, and a document management program that can select an appropriate saving format of an additional electronic document in accordance with a user who saves the electronic document and an attribute of the electronic document.

In order to solve the above problem, the present invention is a document management apparatus that manages saving of an original electronic document and an additional electronic document including the original electronic document and additional information, the document management apparatus including: an acquisition unit operable to acquire the additional electronic document inputted by a user; and a saving control unit operable to determine a saving format of the additional electronic document based on at least one of an attribute of the user and an attribute of the original electronic document, and save the additional electronic document in the determined saving format.

Also, the present invention may be a document management method that manages saving of an original electronic document and an additional electronic document including the original electronic document and additional information, the document management method including: an acquiring step of acquiring the additional electronic document inputted by a user;.and a saving controlling step of determining a saving format of the additional electronic document based on at least one of an attribute of the user and an attribute of the original electronic document, and save the additional electronic document in the determined saving format.

Also, the present invention may be a document management program that causes a document management apparatus to execute document management processing, the document management apparatus managing saving of an original electronic document and an additional electronic document including the original electronic document and additional information, the document management processing including: an acquiring step of acquiring the additional electronic document inputted by a user; and a saving controlling step of determining a saving format of the additional electronic document based on at least one of an attribute of the user and an attribute of the original electronic document, and save the additional electronic document in the determined saving format.

With the above structure, the present invention can control a saving format of an additional electronic document in accordance with an attribute of an original electronic document or an attribute of a user who inputs the additional electronic document, thereby selecting an appropriate saving format to save the additional electronic document.

Here, the saving control unit may determine whether the saving format of the additional electronic document is an overwrite-saving format.

This can prevent unauthorized overwriting of the original electronic document with the additional electronic document and saving the additional electronic document irrelevantly to the attribute of the original electronic document or the attribute of the user who inputs the additional electronic document.

Here, if the determined saving format is the overwrite-saving format, the saving control unit may overwrite the original electronic document with the additional electronic document to save the additional electronic document, and if the determined saving format is not the overwrite-saving format, the saving control unit may save a part or all of the additional electronic document in a storage location different from a storage location of the original electronic document.

Accordingly, if it is impossible to overwrite the original electronic document with the additional electronic document to save the additional electronic document, the additional electronic document can be saved in a saving location different from a saving location of the original electronic document. This can appropriately prevent unauthorized overwriting of the original electronic document, and also can reproduce the additional electronic document later.

Here, the saving control unit may include: a management information acquisition subunit operable to acquire user management information that indicates whether the saving format of the additional electronic document is the overwrite-saving format for overwriting the original electronic document with the additional electronic document and saving the additional electronic document, or a separately-saving format for saving a part or all of the additional electronic document in a storage location different from the storage location of the original electronic document, the saving format of the additional electronic document being defined with respect to the original electronic document and authorized for a plurality of users each of which belongs to one of a plurality of user types; and a determination subunit operable to identify, based on the user management information, whether a saving format authorized for a user type to which the user who inputs the additional electronic document belongs is the overwrite-saving format or the separately-saving format, and determine the identified saving format as the saving format of the additional electronic document.

Accordingly, only a predetermined specific user can be authorized to overwrite an original electronic document with an additional electronic document. This can prevent unauthorized overwriting of original electronic documents by anunauthorizeduser, and also can allow over writing of original electronic documents by an authorized user.

Here, the plurality of user types may include a creator and a non-creator of the original electronic document, and the user management information may indicate that the creator is authorized to use the overwrite-saving format, and the non-creator is authorized to use the separately-saving format.

This can prevent overwriting of the original electronic document with the additional electronic document by a user other than the creator of the original electronic document.

Here, the plurality of user types may include a creator of the original electronic document, a user authorized to perform correction of the original electronic document, and a user who is neither the creator nor the user authorized to perform the correction, and the user management information may indicate that the creator and the user authorized to perform the correction are authorized to use the overwrite-saving format, and the user who is neither the creator nor the user authorized to perform the correction is authorized to use the separately-saving format.

This can prevent overwriting of the original electronic document with the additional electronic document by a user other than the creator or authorized user of the original electronic document.

Here, the saving control unit may include: an information acquisition subunit operable to acquire document attribute information and user management information, the document attribute information indicating whether the saving format of the additional electronic document defined based on an attribute of the original electronic document is the overwrite-saving format for overwriting the original electronic document with the additional electronic document and saving the additional electronic document, or a separately-saving format for saving a part or all of the additional electronic document in the storage location different from the storage location of the original electronic document, and the user management information indicating whether a saving format authorized for a plurality of users each of which belongs to one of a plurality of user types is the overwrite-saving format or the separately-saving format; and a determination subunit operable, by comparing the saving format indicated by the acquired document attribute information and a saving format authorized for a user type to which the user who inputs the additional electronic document belongs in the user management information, to determine the saving format of the additional electronic document.

Accordingly, a saving format of the additional electronic document can be determined in accordance with the correspondence between the attribute of the original electronic document and the user type, thereby saving the additional electronic document in an appropriate saving format in accordance with the importance level of the original electronic document and the user's authority.

Here, the plurality of user types may include a creator of the original electronic document, a user authorized to perform correction of the original electronic document, and a user who is neither the creator nor the user authorized to perform the correction, the user management information may indicate that the creator and the user authorized to perform the correction are authorized to use the overwrite-saving format, and the user who is neither the creator nor the user authorized to perform the correction is authorized to use the separately-saving format, and if the saving format indicated by the document attribute information is the overwrite-saving format and the saving format authorized for the user type to which the user who inputs the additional electronic document belongs is the separately-saving format, the determination subunit may determine the separately-saving format as the saving format of the additional electronic document.

Accordingly, if the original electronic document is an approval document that needs approval of a user having a specific authority for example, only the user having the authority can overwrite the original electronic document with image data of an additional electronic document having an approval stamp, etc. added thereto. This can prevent unauthorized approval by an unauthorized user, and can prevent overwriting of the original electronic document with the additional electronic document.

Here, if the determined saving format is not the overwrite-saving format but a part-separately-saving format for saving the part of the additional electronic document in the storage location different from the storage location of the original electronic document, the saving control unit may save the part in correspondence with the original electronic document.

Also, the document management apparatus may include an extraction unit operable to extract the additional information from the additional electronic document, wherein the part of the additional electronic document may be the extracted additional information.

Accordingly, a part of an additional electronic document can be separately saved in correspondence with an original electronic document thereof. Therefore, by separately saving only additional information in correspondence with the original electronic document for example, the original electronic document can be composed of the additional information, thereby easily reproducing the additional electronic document, when needed. This can reduce a memory region needed for saving, compared with the case where all of the additional electronic document are separately saved.

Here, if the determined saving format is not overwrite save and a part or all of the additional electronic document is saved in a storage location different from the storage location of the original electronic document, the saving control unit may save the part or all in a personal folder in correspondence with an identifier of the user who inputs the additional electronic document.

Accordingly, a user who inputs an additional electronic document can easily reproduce the self-created additional electronic document by accessing his own personal folder, when needed.

Here, the saving control unit may include: a management information acquisition subunit operable to acquire user management information that indicates, for each user type, whether an authorized saving format of the additional electronic document is an overwrite-saving format for overwriting the original electronic document with the additional electronic document and saving the additional electronic document, or a separately-saving format for saving a part or all of the additional electronic document separately from the original electronic document; a judgment subunit operable to judge the attribute of the original electronic document; and a determination subunit operable to, based on the saving format of the additional electronic document authorized for a user type to which the user who inputs the additional electronic document belongs and a result of the judgment by the judgment subunit, determine the overwrite-saving format or the separately-saving format as the saving format of the additional electronic document.

Accordingly, a saving format of the additional electronic document can be controlled in accordance with user types. This can effectively prevent the following trouble, for example: an unauthorized user additionally writes to an original electronic document such as an approval document to which only a specified authorized user can additionally write, and overwrites the original electronic document registered in the data base. Also, this can cause each user who-accesses the electronic document to save the electronic document in an appropriate saving format, and can secure security in electronic document saving.

Also, since an appropriate saving format can be selected in accordance with a relative relation with an attribute of an electronic document, security in electronic document saving can be secured and also a convenient saving format can be selected. For example, even in the case where an original electronic document can be overwritten based on a user's authority, if the original electronic document has a low resolution, the original electronic document can be saved in a separately-saving format. Therefore, even if a character around an additionally written portion of an additional electronic document outputted in paper form is unclear and is difficult to read, the original electronic document is outputted, thereby easily reading the original electronic document to check the character.

Here, the document management apparatus may manage saving of a plurality of original electronic documents and additional electronic documents to which additional information with respect to each of the plurality of original electronic documents is added, the user management information may be created for each original electronic document managed by the document management apparatus, and the determination subunit may determine the overwrite-saving format or the separately-saving format as the saving format of the additional electronic document, based on the saving format of the additional electronic document authorized for the user type to which the user who inputs the additional electronic document belongs in the user management information created with respect to the original electronic document of the inputted additional electronic document and the result of the judgment by the judgment subunit.

Accordingly, a saving format for each electronic document can be set in accordance with user's authority, thereby switching security level for saving electronic documents depending on the type of electronic documents.

Here, the judgment subunit may include: a specific information acquisition subunit operable to acquire resolution specific information that indicates resolution of the original electronic document that is an addition object; and a resolution judgment subunit operable to judge whether the resolution of the original electronic document that is the addition object is low, depending on whether the resolution indicated by resolution specific information is less than a threshold value, wherein if the saving format is the overwrite-saving format and the resolution judgment subunit judges affirmatively, the determination subunit determines the separately-saving format as the saving format of the additional electronic document.

Accordingly, if an original electronic document has a low resolution, the separately-saving format is selected in preference to the overwrite-saving format. Therefore, even if a character around an additionally written portion on the original paper document outputted in paper form is difficult to read, the original electronic document is outputted, thereby easily reading the original electronic document to check the character.

Here, the document management apparatus may include: an output unit operable to output the original electronic document managed by the document management apparatus in a plurality of outputting formats including a network outputting format; and a difference extraction unit operable to extract, as additional information, differential data between the additional electronic document and the original electronic document; wherein the user management information indicates, for each user type, whether an authorized saving format of the original electronic document is the overwrite-saving format, an all-separately-saving format for saving the additional electronic document separately from the original electronic document, or a part-separately-saving format for saving only the extracted additional information separately from the original electronic document, and the judgment subunit may include: a creation subunit operable to, each time the original electronic document is outputted, create output specific information for specifying an outputting format of the original electronic document; and a highest output frequency judgment subunit operable to judge which outputting format is a outputting format having a highest output frequency of the original electronic document, based on the created output specific information, wherein if the saving format is the part-separately-saving format and the output unit judges affirmatively, the determination subunit determines the all-separately-saving format as the saving format of the additional electronic document.

Accordingly as for an electronic document that is frequently outputted via a network, the all-separately-saving format is selected in which the original electronic document and an added portion are saved together without separation, in preference to the part-separately-saving format in which the original electronic document and the added portion are separately saved. This can achieve speed-up in electronic document outputting.

Here, the document management apparatus may include a difference extraction unit operable to extract, as additional information, differential data between the additional electronic document and the original electronic document; wherein the user management information indicates, for each user type, whether an authorized saving format of the original electronic document is the overwrite-saving format, an all-separately-saving format for saving the additional electronic document separately from the original electronic document, or a part-separately-saving format for saving only the extracted additional information separately from the original electronic document, the judgment subunit judges whether a data size of the original electronic document is no less than a threshold value, and if the saving format is the all-separately-saving format and the judgment subunit judges affirmatively, the determination subunit determines the partly-saving format as the saving format of the additional electronic document.

Accordingly, if the data size of an original electronic document is large, the part-separately-saving format is selected in which an added portion is saved separately saved, in preference to the all-separately-saving format in which the original electronic document and the added portion are saved as one. This can effectively prevent wasteful consumption of a memory caused by saving of many large size data as added data.

Here, the original electronic document may be inputted to the document management apparatus in a plurality of inputting formats including a fax inputting format, the judgment subunit may judge whether the original electronic document is inputted in the fax inputting format, and if the determined saving format is the overwrite-saving format and the judgment subunit judges affirmatively, the determination subunit may determine the part-separately-saving format as the saving format of the additional electronic document.

Accordingly, an electronic document received by fax is forbidden to be overwritten and be saved. This can prevent erroneous overwriting of an important document received by fax from external clients, etc. with an additional electronic document.

Here, the original electronic document and the additional electronic document are image data read from paper documents.

Accordingly, it is not necessary to file, as paper documents, an original document and a document to which additional information is added to the original document. Instead, these documents can be saved and managed as image data in an appropriate saving format.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the Drawings:

FIG. 1 is a functional block diagram showing a structure of a document management system 100 according to an embodiment of the present invention;

FIG. 2 is a block diagram showing a functional structure of a document management apparatus 101;

FIG. 3 shows specific examples of document attribute information;

FIG. 4 shows a specific example of document-classified management information;

FIG. 5 shows a specific example of original input attribute information;

FIG. 6 shows a specific example of original output attribute information;

FIG. 7 is a functional block diagram showing a structure of a data base 103;

FIG. 8 shows a specific example of general management information;

FIG. 9 is a flow chart showing operations of added data saving control processing performed by a central processing unit 1013;

FIG. 10 is a part of a flow chart showing operations of saving format determination processing performed by a saving format determination unit 10133; and

FIG. 11 is a part of the flow chart showing the operations of the saving format determination processing performed by the saving format determination unit 10133.

### DESCRIPTION OF THE PREFERRED EMBODIMENT

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

The following describes a preferred embodiment of the present invention, with reference to the drawings.

### <Structure>

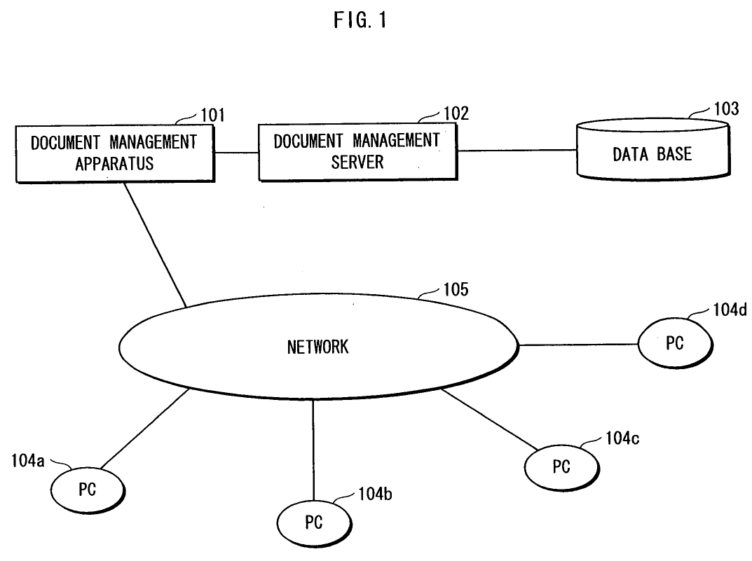

FIG. 1 is a functional block diagram showing a structure of a document management system 100 according to an embodiment of the present invention.

The document management system 100 (an MFP (Multi-Function Peripheral) is used here) includes a document management apparatus 101, a document management server 102, a data base 103, and PCs 104a to 104d. The document management apparatus 101 and the PCs 104a to 104d are mutually connected via a network 105.

### (Document Management Apparatus 101)

### (Hardware Configuration)

The document management apparatus 101 in the present embodiment includes a microprocessor, a ROM, a RAM, a hard disk unit, a display unit composed of a liquid crystal display, a CRT, etc., a keyboard, a mouse, a scanner, an image printer such as a laser printer, and so on. A computer program is stored in the RAM or the hard disk unit. The document management apparatus 101 achieves functions in a functional structure described below by the microprocessor operating in accordance with the computer program. Here, the computer program is composed of a plurality of instruction codes that indicate instructions to a computer, in order to achieve a predetermined function.

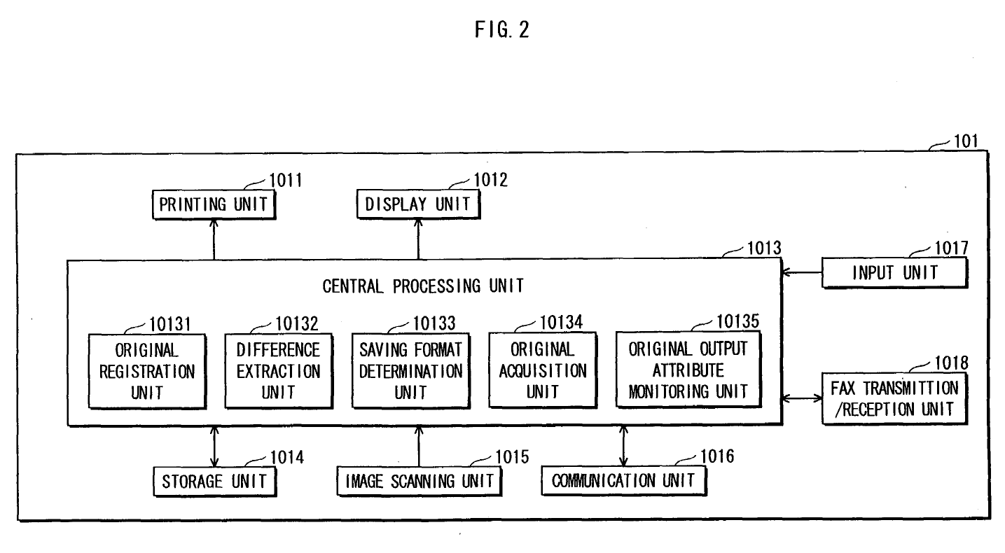

FIG. 2 is a functional block diagram showing the functional structure of the document management apparatus 101. The document management apparatus 101 includes a print unit 1011, a display unit 1012, a central processing unit 1013, a storage unit 1014, an image scanning unit 1015, a communication unit 1016, an input unit 1017, and a fax transmission/reception unit 1018.

### (Print Unit 1011)

The print unit 1011 includes an image printer such as a laser printer, prints image data on a recording paper based on an electronic document inputted by the central processing unit 1013 to output the image data as a paper document.

Here, the outputted paper document includes storage location information indicating a storage location of an electronic document as an original text of the outputted paper document (hereinafter referred to as “original electronic document”) in the data base 103.

The storage location information may be embedded in a paper document as a one-dimensional bar code or a two-dimensional bar code, and be outputted as visible image data, for example. Also, the storage location information may be embedded in a paper document as invisible image data using an electronic watermarking method, or may be embedded in a paper document using a pattern, etc.

### (Display Unit 1012)

The display unit 1012 includes a liquid crystal display, a CRT, and so on, and displays data inputted by the central processing unit 1013 on a screen thereof.

### (Central Processing Unit 1013)

The central processing unit 1013 includes an original registration unit 10131, a difference extraction unit 10132, a saving format determination unit 10133, an original acquisition unit 10134, and an original output attribute monitoring unit 10135, and controls the whole document management apparatus 101.

### (Original Registration Unit 10131)

The original registration unit 10131 performs each of the following processing.

### 1. Original Registration Processing

If registration of an original electronic document is requested by the communication unit 1016 or the input unit 1017, the original registration unit 10131 requires a request source of the registration to input a user ID (a staff number is used here) and a password, and performs authentication of the request source.

If the request source is authenticated, the original registration unit 10131 directs the request source to input the original electronic document. If the request source is not authenticated, the original registration unit 10131 notifies the request source of authentication failure.

If the request source is authenticated, the original registration unit 10131 receives the original electronic document, document attribute information thereof, and document-classified management information thereof, which are inputted by a creator of the original electronic document (an addressee in the case where the original electronic document is received by fax). And then, the original registration unit 10131 stores the original electronic document, the document attribute information, and the document-classified management information in the data base 103 via the document management server 102.

Note that, if an original electronic document is received by fax, the original registration unit 10131 stores the original electronic document in the data base 103 at the time of fax reception. Then, an addressee of the fax-received original electronic document requests registration of document attribute information and document-classified management information relating to the original electronic document to the original registration unit 10131 via the communication unit 1016 or the input unit 1017. And then, the original registration unit 10131 stores corresponding document attribute information and document-classified management information in the data base 103.

The document attribute information and the document-classified management information are each stored in the data base 103 in correspondence with the original electronic document (here, corresponded by original electronic document identification information).

Here, the “document attribute information” indicates information composed of original electronic document identification information as an identifier of the original electronic document, a category of the original electronic document (for example, a standard business document, an approval document, a circulation document such as a conference report, image data, and so on), a judgment mode, and color identification information that indicates distinction between color and monochrome in the original electronic document.

Moreover, the “judgment mode” indicates information for specifying whether a saving format of added data of the electronic document should be individually judged based on below-described document-classified management information, or should be uniformly judged based on below-described general management information.

Here, the “added data” indicates electronic data created in the following way: additional writing is performed on the original document by the user, then the additionally written paper document is read by the scanner, etc. and is electronized.

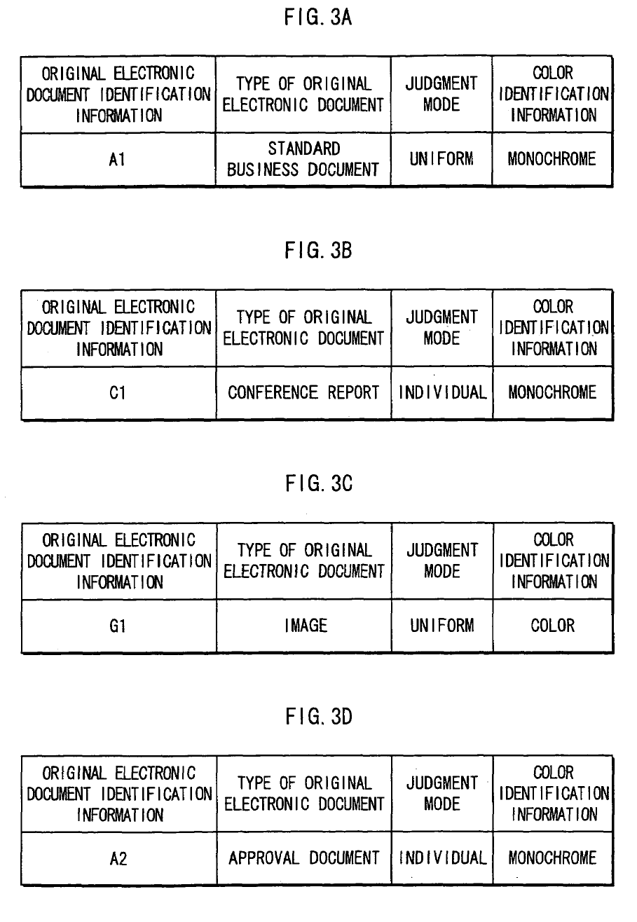

FIGS. 3A to 3D show specific examples of document attribute information. FIG. 3A shows document attribute information of an original electronic document whose original electronic document identification information is “A1”. According to the document attribute information, the original electronic document has a type “standard business document”, a judgment mode “uniform” that indicates a saving format of added data is uniformly judged based on below-described general management information, and color identification information indicating “monochrome”.

FIG. 3B shows document attribute information of an original electronic document whose original electronic document identification information is “C1”. According to the document attribute information, the original electronic document has a type “conference report”, a judgment mode “individual” that indicates a saving format of added data is individually judged based on below-described document-classified management information, and color identification information indicating “monochrome”.

FIG. 3C shows document attribute information of an original electronic document whose original electronic document identification information is “G1”. According to the document attribute information, the original electronic document has a type “image”, a judgment mode “uniform” that indicates a saving format of added data is uniformly judged based on below-described general management information, and color identification information indicating “color”.

FIG. 3D shows document attribute information of an original electronic document whose original electronic document identification information is “A2”. According to the document attribute information, the original electronic document has a type “approval document”, the judgment mode “individual” that indicates a saving format of added data is individually judged based on below-described document-classified management information, and color identification information indicating “monochrome”.

Moreover, the “document-classified management information” indicates information that shows correspondence between (a) a user type such as a creator, manager, and correction authorized user of an original electronic document identified by original electronic document identification information, and (b) a saving format of added data relating to the original electronic document authorized for a user who belongs to each user type.

Note that, a user judges whether to individually set a saving format of added data depending on document attribute of the original electronic document. If a saving format of the added data is individually set, document-classified management information is created. If a saving format of the added data is set based on below-described general management information, document-classified management information is not created.

Here, the “saving format of added data” indicates information for specifying a saving format of added data, and is predetermined in accordance with a user type.

Here, as a saving format of added data, “overwrite save”, “part separately save”, and “all separately save” are predetermined. In the “overwrite save”, an original electronic document relating to the added data (hereinafter “adding target original”) stored in the data base 103 is rewritten to the added data, and the added data is stored in the data base 103. In the “part separately save”, the adding target original is not rewritten. Differential information extracted with respect to the added data is stored in the storage unit 1014 of the document management apparatus 101, added data related information is created that shows correspondence between a storage location of the differential information and a storage location of the adding target original, and the added data related information is stored in the storage unit 1014. In the “all separately save”, the adding target original is not rewritten, and the added data is stored in the storage unit 1014.

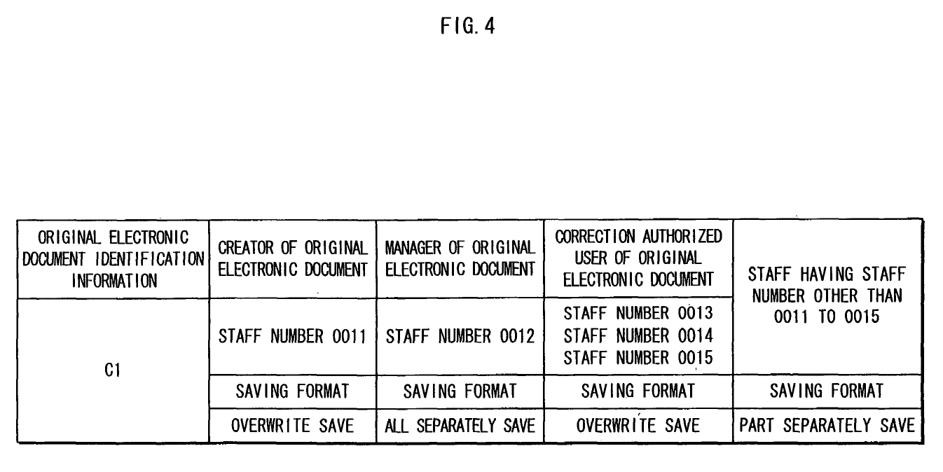

FIG. 4 shows a specific example of document-classified management information. Document-classified management information shown in FIG. 4 is document-classified management information of the original electronic document whose original electronic document identification information is “C1” (specifically, the original electronic document whose type is a “conference report” shown in FIG. 3B). A staff who belongs to a user type “creator of original electronic document” having a staff number 0011 is authorized to use “overwrite save” as a saving format of added data of the original electronic document. A staff who belongs to a user type “manager of original electronic document” having a staff number 0012 is authorized to use “all separately save” as a saving format of added data of the original electronic document. Each staff who belongs to a user type “correction authorized user of original electronic document” having staff numbers 0013 to 0015 is authorized to use ” overwrite save” as a saving format of the added data. Each staff who does not belong to the above-mentioned user types “creator of original electronic document”, “manager of original electronic document”, and “correction authorized user of original electronic document” (specifically, staff who has a staff number other than 0011 to 0015) is authorized to use “part separately save” as a saving format of added data of the original electronic document.

Note that, a creator of an original electronic document inputs document attribute information and document-classified management information, at the time when the creator creates the original electronic document, for example. If the original electronic document is received by fax, a receiver of the fax-received original electronic document inputs document attribute information and document-classified management information thereof by via the input unit 1017 or the PCs 104a to 104d, at the time when the receiver views the original electronic document.

### 2. Added Data Registration Processing

If registration of added data is requested from the communication unit 1016 or the input unit 1017, the original registration unit 10131 performs authentication processing of a request source of the registration as the same way as the original registration processing.

If the request source is authenticated, the original registration unit 10131 acquires an original electronic document relating to the added data, and document attribute information, original input attribute information, and original output attribute information that are in correspondence with the original electronic document from the data base 103. And then, the original registration unit 10131 directs the difference extraction unit 10132 to acquire differential information between the acquired original electronic-document and the inputted added data.

Moreover, in accordance with a saving format of the added data determined in below-described saving format determination processing performed by the preservation manner deciding part 10133, the original registration unit 10131 stores the added data or the differential information in a storage location indicated by the saving format.

### 3. Original Input Attribute Information Creation Processing

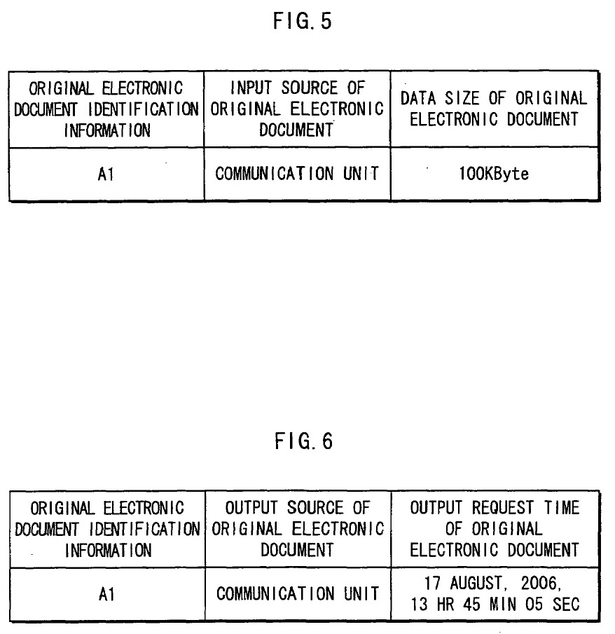

Upon receiving input of an original electronic document from the communication unit 1016, the image scanning unit 1015, and the fax transmission/reception unit 1018, the original registration unit 10131 identifies the data size of the inputted original electronic document, and then judges whether an input source of the original electronic document is the communication unit 1016, the image scanning unit 1015, or the fax transmission/reception unit 1018. Based on a result of the judgment, the original registration unit 10131 creates original input attribute information that shows correspondence among the original electronic document, the judged input source, and the data size of the original electronic document, and stores the inputted original electronic document in the data base 103 in correspondence with the created original input attribute information via the document management server 102. FIG. 5 shows a specific example of original input attribute information original input attribute information shown in FIG. 5 is original input attribute information of the original electronic document whose original electronic document identification information is “A1” (specifically, the original electronic document whose type is “standard business document” shown in FIG. 3A). According to the original input attribute information, the original electronic document is inputted by an input source “communication unit”, and has a data size of “100 KByte”.

Moreover, the original registration unit 10131 stores original output attribute information inputted by the original output attribute information monitoring unit 10135 in the data base 103 via the document management server 102.

### (Difference Extraction Unit 10132)

The user adds by handwriting, etc. to a paper document having image data based on an original electronic document of the paper document outputted thereon by the print unit 1011. The user causes the image scanning unit 1015 to read the paper document added by handwriting, and thereby, the difference extraction unit 10132 receives added data of the paper document and storage location information of an original electronic document relating to the added data from the image scanning unit 1015.

Moreover, if the user inputs image data of added data via the PCs 104a to 104d (specifically, scanners connected to the PCs), the difference extraction unit 10132 receives the image data of the added data and storage location information of an original electronic document relating to the added data from the communication unit 1016.

Next, the difference extraction unit 10132 notifies the original acquisition unit 10134 of the storage location information, acquires image data of the original electronic document from a storage location indicated by the storage location information in the data base 103 via the original acquisition unit 10134, and then extracts a difference (hereinafter “differential information”) between the acquired image data of the original electronic document and the image data of the added data.

### (Saving Format Determination Unit 10133)

The saving format determination unit 10133 performs saving format determination processing. First, based on document-classified management information stored in the data base 103 or below-described general management information, the saving format determination unit 10133 temporarily selects a saving format of added data via the document management server 102. Next, based on a correlation among the selected saving format, a document attribute, an input attribute, and an output attribute of the original electronic document, the saving format determination unit 10133 determines whether to set the selected saving format as a saving format of the added data without change, or to change the selected saving format into another saving format.

In the above determination processing, based on the document attribute information, the original input attribute information, and the original output attribute information acquired by the original registration unit 10131, the saving format determination unit 10133 identifies the document attribute, the input attribute, and the output attribute of the original electronic document. And then, based on whether the selected saving format and each of the identified attributes are in a predetermined correlation, the saving format determination unit 10133 determines whether to determine the selected saving format as a saving format of the added data, or to change the selected saving format into another saving format.

That is, in the case where the added data is saved in the selected saving format without change, if a drawback is observed in the correlation between the selected saving format and the attributes (resolution, data size, output mode, input mode), the saving format determination unit 10133 changes the selected saving format into a saving format matched to the attributes, and determines the changed saving format as a saving format of the added data. If such drawback is not observed, the saving format determination unit 10133 determines the selected saving format as a saving format of the added data.

Note that, the operations of the determination processing of saving format is described later in detail.

### (Original Acquisition Unit 10134)

Based on storage location information that indicates a storage location of an original electronic document inputted by the image scanning unit 1015 or the communication unit 1016, the original acquisition unit 10134 acquires a corresponding original electronic document from the data base 103 via the document management server 102.

Specifically, a scanner connected to the image scanning unit 1015 or the PCs 104a to 104d reads the storage. location information stored on a paper document, and outputs the read storage location information to the central processing unit 1013. The original acquisition unit 10134 analyzes the inputted storage location information, and thereby acquires image data of the original electronic document corresponding to the paper document from the storage location in the data base 103 indicated by the storage location information via the document management server 102.

### (Original Output Attribute Monitoring Unit 10135)

The original output attribute monitoring unit 10135 includes a time measuring unit that measures a current time. Each time output of an original electronic document is requested by the input unit 1017 and the communication unit 1016, the original output attribute monitoring unit 10135 acquires an output request time from the time measuring unit, and identifies whether an output source of the request is the communication unit 1016, the print unit 1011, or the fax transmission/reception unit 1018. The original output attribute monitoring unit 10135 creates original output attribute information that shows correspondence among the identified output source, the original electronic document requested to be outputted, and the acquired output request time, and outputs the original output attribute information to the original registration unit 10131.

FIG. 6 shows a specific example of original output attribute information. Original output attribute information shown in FIG. 6 is original output attribute information of the original electronic document whose original electronic document identification information is “A1” (specifically, the original electronic document whose type is the “standard business document” shown in FIG. 3A). According to this original output attribute information, the original electronic document is outputted by an output source “communication unit”, and the communication unit requests output of the original electronic document at “17 Aug., 2006, 13 hr 45 min 05 sec”.

### (Storage Unit 1014)

The storage unit 1014 includes a hard disk drive, or a removable storage device such as a floppy disk, a magneto-optic disk, an IC card. The storage unit 1014 stores differential information, added data, a threshold value used for resolution judgment of an original electronic document in operations of below-described saving format determination processing (hereinafter “threshold value 1”), a threshold value used for data size judgment of an original electronic document (hereinafter “threshold value 2”), etc.

### (Image Scanning Unit 1015)

The image scanning unit 1015 includes an image input apparatus such as a scanner, and irradiates image data stored on a paper document, such as a character, a bar code, a drawing, a table, and a photograph using a built-in light source, forms reflected image data on a solid state image pickup device using a lens, converts the formed reflected image data into an image signal via the solid state image pickup device, and outputs the converted image signal-to the central processing unit 1013.

### (Communication Unit 1016)

The communication unit 1016 is an interface for connecting with the network 105, and connects with the document management server 102 and the PCs 104a to 104d via the network 105.

### (Input Unit 1017)

The input unit 1017 includes an input device such as a touch panel and a keyboard, receives instructions inputted by the user, and outputs the inputted instructions to the central processing unit 1013.

### (Document Management Server 102)

The document management server 102 is a server that manages the data base 103, and in accordance with a request from the document management apparatus 101, stores data such as an original electronic document in the data base 103, and outputs data stored in the data base 103.

### (Data Base 103)

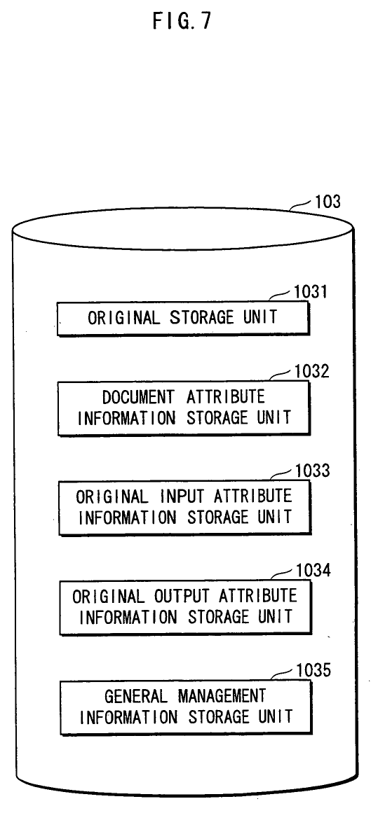

FIG. 7 is a functional block diagram showing a structure of the data base 103. The data base 103 includes an original storage unit 1031, a document attribute information storage unit 1032, an original input attribute information storage unit 1033, an original output attribute information storage unit 1034, and a management information storage unit 1035.

### (Original Storage Unit 1031)

The original storage unit 1031 stores an original electronic document or added data relating to the original electronic document in correspondence with storage location information thereof.

Moreover, the electronic document or the added data of the original electronic document is correlated with document attribute information thereof, document-classified management information thereof, original input attribute information thereof, and original output attribute information thereof, respectively.

### (Document Attribute Information Storage Unit 1032)

The document attribute information storage unit 1032 stores document attribute information.

### (Original Input Attribute Information Storage Unit 1033)

The original input attribute information storage unit 1033 stores original input attribute information of each original electronic document.

### (Original Output Attribute Information Storage Unit 1034)

The original output attribute information storage unit 1034 stores original output attribute information of each original electronic document.

### (General Management Information Storage Unit 1035)

The general management information storing unit 1035 stores general management information.

Here, “general management information” indicates information used for determining a saving format of added data of an original electronic document whose document-classified management information has not been created, where the saving format needs not to be managed in units of original electronic document. Specifically, “general management information” indicates information that shows correspondence between a user type such as a job position and a title, and a saving format authorized for a user who belongs to each user type.

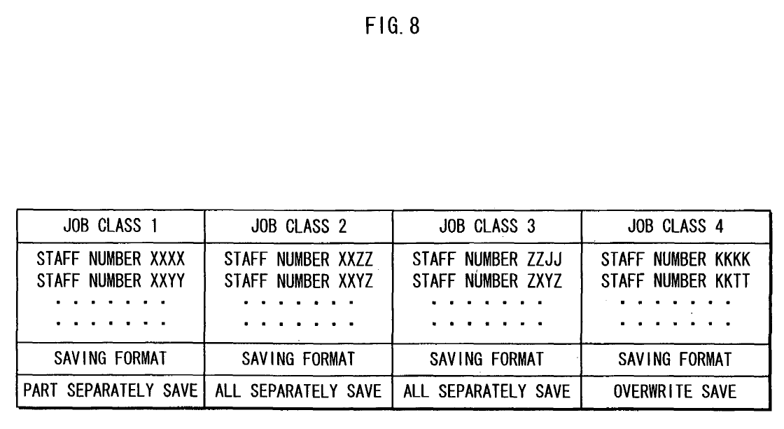

FIG. 8 shows a specific example of general management information. General management information shown in FIG. 8 is a saving format of added data set for each “job class” that indicates user's job position. A staff who has a staff number belonging to “job class 1” is authorized to use “part separately save”. A staff who has a staff number belonging to “job class 2” and “job class 3” is authorized to use “all separately save”. A staff who has a staff number belonging to “job class 4” is authorized to use “overwrite save”.

### (PCs 104a to 104d)

Each of the PCs 104a to 104d includes a computer, a scanner, and so on, and transmits an original electronic document created by user keyboard input and an original electronic document inputted by the scanner to the communication unit 1016 of the document management apparatus 101 via the network 105.

Moreover, each of the PCs 104a to 104d transmits document attribute information and document-classified management information created by user keyboard input to the communication unit 1016 of the document management apparatus 101 via the network 105.

### <Operation>

### (Added Data Saving Control Processing)

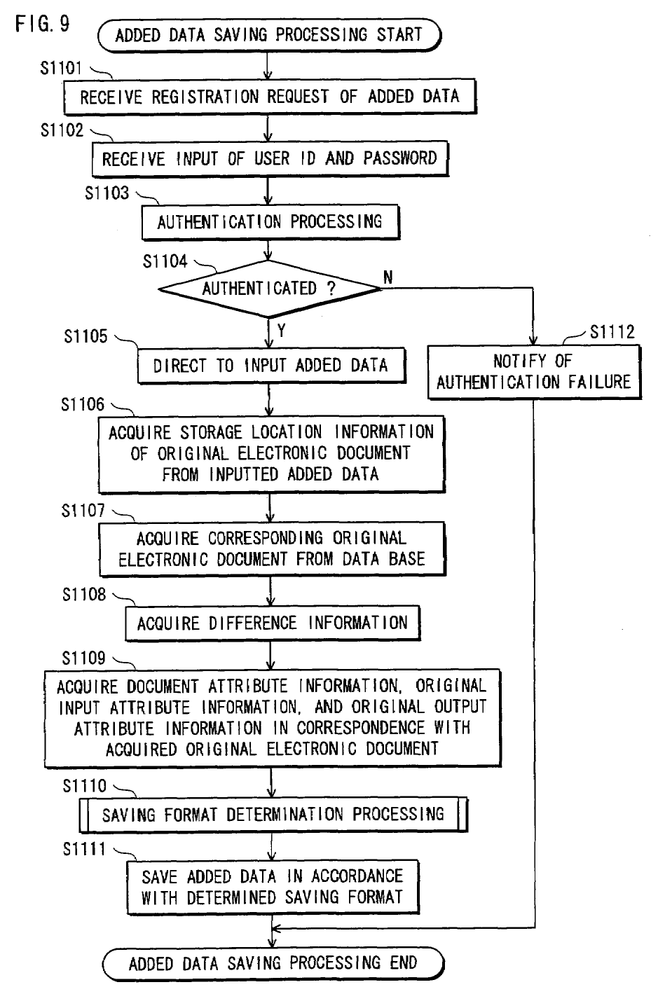

Next, the operations of the added data saving control processing performed by the central processing unit 1013 is described. FIG. 9 is a flow chart showing the above-mentioned operations.

If registration of added data is requested by the communication unit 1016 or the input unit 1017 (STEP S1101), the original registration unit 10131 requires a request source of the registration to input a user ID and a password. Upon receiving input of the user ID and the password from the request source of the registration (STEP S1102), the original registration unit 10131 performs authentication processing of the request source (STEP S1103). If the request source is authenticated (STEP S1104: Y), the original registration unit 10131 directs the request source to input image data of the added data (STEP S1105). Upon receiving the input of the image data of the added data from the communication unit 1016 or the image scanning unit 1015, the original registration unit 10131 causes the difference extraction unit 10132 to acquire the inputted image data of the added data and storage location information of an original electronic document stored in the added data (STEP S1106). Based on the storage location information, the original registration unit 10131 acquires image data of a corresponding original electronic document from the data base 103 (STEP S1107). Subsequently, the original registration unit 10131 causes the difference extraction unit 10132 to acquire differential information between the acquired image data of the original electronic document and the image data of the added data (STEP S1108). Furthermore, the original registration unit 10131 acquires document attribute information, original input attribute information, and original output attribute information in correspondence with the original electronic document from the data base 103 (STEP S1109).

Next, the saving format determination unit 10133 performs below-described saving format determination processing (STEP S1110).

And then, the original registration unit 10131 saves the image data of the added data in accordance with a determined saving format (STEP S1111).

In STEP S1104, if the request source is not authenticated (STEP S1104: N), the original registration unit 10131 notifies the request source of authentication failure (STEP S1112).

### (Saving Format Determination Processing)

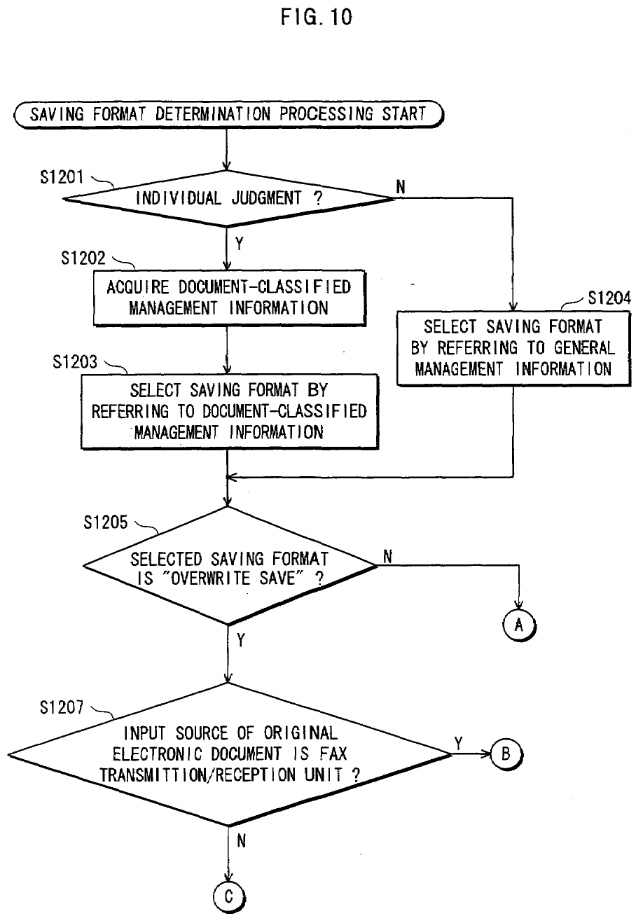

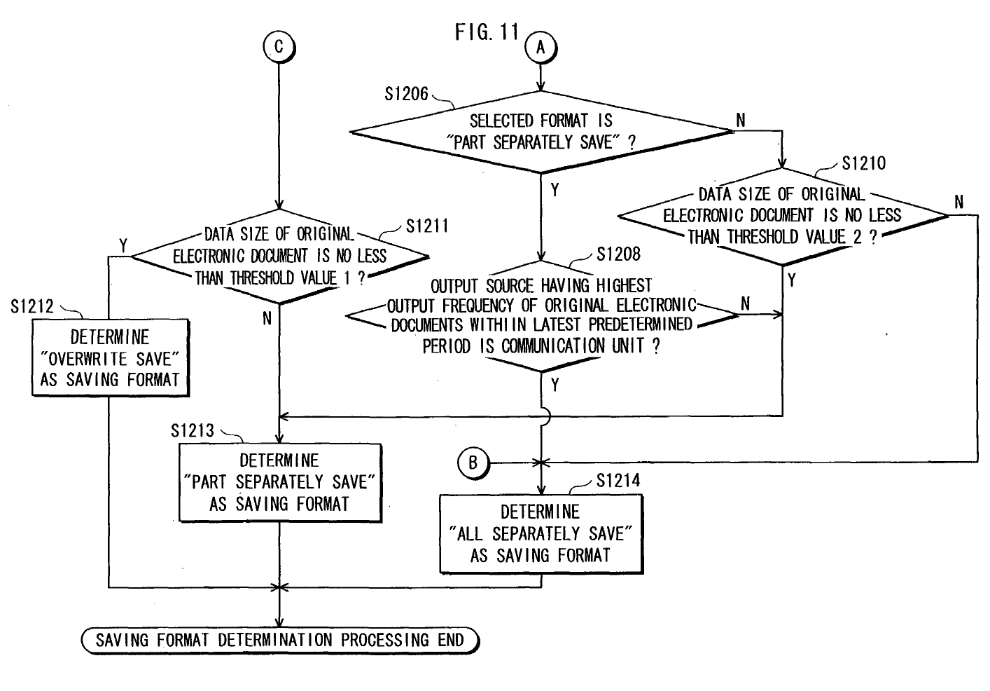

Next, the operations of the saving format determination processing performed by the saving format determination unit 10133 is described. FIG. 10 and FIG. 11 are flow charts each showing the above-mentioned operations.

The saving format determination unit 10133 refers to “judgment mode” indicated by the document attribute information acquired by the original registration unit 10131, to judge whether a saving format of the added data is individually judged based on document-classified management information or uniformly judged based on general management information (STEP S1201).

If the saving format is individually judged (STEP S1201: Y), the saving format determination unit 10133 acquires the document-classified management information in correspondence with the acquired original electronic document from the data base 103 via the original acquisition unit 10134 (STEP S1202). And, the saving format determination unit 10133 refers to the acquired document-classified management information to select a saving format of the added data corresponding to the user ID inputted in STEP S1102 of the added data saving control processing (STEP S1203). Then, the processing proceeds to STEP S1205.

Also, if the saving format is uniformly judged (STEP S1201: N), the saving format determination unit 10133 acquires the general management information from the data base 103 via the original acquisition unit 10134. The saving format determination unit 10133 refers to the acquired general management information to select a saving format of the added data corresponding to the user ID inputted in STEP S1102 of the added data saving control processing (STEP S1204). Then, the processing proceeds to STEP S1205.

In STEP S1205, the saving format determination unit 10133 judges whether the selected saving format is “overwrite-save”. If the selected saving format is “overwrite-save” (STEP S1205: Y), the saving format determination unit 10133 refers to the acquired original input attribute information of the original electronic document to judge whether an input source of the original electronic document is the fax transmission/reception unit 1018 (STEP S1207). If the input source is the fax transmission/reception unit 1018 (STEP S1207: Y), the saving format determination unit 10133 determines “all-separately-save” as a saving format of the added data, instead of “overwrite-save” (STEP S1214).

If the selected saving format is not “overwrite-save” (STEP S1205: N), the saving format determination unit 10133 judges whether the selected saving format is “part separately save” (STEP S1206). If the selected saving format is “part-separately-save” (STEP S1206: Y), the saving format determination unit 10133 refers to the acquired original output attribute information of the original electronic document to identify an output source having a highest output frequency of original electronic documents within the latest predetermined period and to judge whether the output source is the communication unit 1016 (STEP S1208). If the output source is the communication unit 1016 (STEP S1208: Y), the saving format determination unit 10133 determines “all-separately-save” as a saving format of the added data, instead of “part-separately-save” (STEP S1214).

If the input source is not the fax transmission/reception unit 1018 (STEP S1207: N), the saving format determination unit 10133 estimates resolution quality of the image data of the original electronic document depending on whether the data size of the acquired original input attribute information of the original electronic document is no less than the threshold value 1 (STEP S1211).

Here, a resolution is not necessarily correlated with the data size, depending on a compression format, etc. Therefore, the resolution quality may be estimated depending on whether color identification information of the document attribute information indicates color or monochrome. Also, the following may be employed. The user beforehand inputs a resolution value of the image data to the document attribute information, and the resolution is estimated depending on whether the inputted resolution value is no less than a predetermined level.

In STEP S1211, if the data size is less than the threshold value 1 (STEP S1211: N), the saving format determination unit 10133 determines “part-separately-save” as a saving format of the added data, instead of the selected saving format “overwrite-save” (STEP S1213).

If the data size is no less than the threshold value 1 (STEP S1211: Y), the saving format determination unit 10133 determines the selected saving format “overwrite-save” as a saving format of the added data (STEP S1212).

In STEP S1206, if the selected saving format is not “part-separately-save” (that is, “all-separately-save” STEP S1206: N), the saving format determination unit 10133 judges whether the data size of the original input attribute information of the original electronic document is no less than the threshold value 2 (STEP S1210). If the data size is no less than the threshold value 2 (STEP S1210: Y), the saving format determination unit 10133 determines “part-separately-save” as a saving format of the added data, instead of the selected saving format “all-separately-save” (STEP S1213).

In STEP S1208, if the output source is not the communication unit 1016 (STEP S1208: N), the saving format determination unit 10133 determines the selected saving format “part-separately-save” as a saving format of the added data (STEP S1213).

In STEP S1210, if the data size is less than the threshold value 2 (STEP S1210: N), the saving format determination unit 10133 determines the selected saving format “all-separately-save” as a saving format of the added data (STEP S1214).

### <Supplementary Description>

Although the document management system 100 according to the present invention has been described based on the embodiment, needless to say, the present invention is not limited to the above embodiment.
(1) In the present embodiment, as a saving format of added data to be a selection target, three formats are employed: “overwrite-save”, “all-separately-save”, and “part-separately-save”. However, without limiting to the three formats, three or more and less than three formats may be employed as a saving format.

For example, “non-relationpart-separately-save” may be added as a saving format of added data, where, added data related information is not created, and only differential information extracted with respect to added data is stored in the storage unit 1014.

Moreover, in the present embodiment, if a saving format of added data is other than “overwrite-save”, differential information and the added data are stored in the storage unit 1014. However, without limiting to the storage in the storage unit 1014, the differential information and the added data may be stored in the hard disk drives of the PCs 104a to 104d, and also may be saved separately from an original electronic-document in the data base 103.
(2) In the present embodiment, if a saving format of added data is “part-separately-save”, added data related information is created, and an adding target original is correlated with differential information extracted with respect to the added data. However, the following may be employed. Instead of creating added data related information, a personal folder for each user, for example in correspondence with each staff number, is created beforehand, and is stored in a storage region of the storage unit 1014. And extracted differential information is stored in a personal folder corresponding to a staff number who requests registration of the added data. Furthermore, a saving format of added data is “all-separately-save”, the added data is stored in a personal folder corresponding to a staff number who requests registration of the added data.
(3) In the present embodiment, in the operations of the saving format determination processing, if the data size is no less than the threshold value 1 (STEP S1211: N), “part-separately-save” is determined as a saving format of the added data, as shown in FIG. 11. However, “all-separately-save” l may be also employed.

Also, in STEP S1207, if the input source of the original electronic document is the fax transmission/reception unit 1018 (STEP S1207: Y), “all-separately-save” is determined as a saving format of the added data. However, “part-separately-save” may be also employed.

Furthermore, in STEP S1210, the data size is judged using the data size of the original electronic document. However, the data size may be also judged using the data size of the image data of the added data.
(4) In the present embodiment, in the operations of the saving format determination processing, if the judgment result in STEP S1201 is the uniform judgment, the saving format is determined by referring to the general management information, as shown in FIG. 10. However, the followings may be also employed. In the document attribute information, a saving format is defined in accordance with a type of an original electronic document: “overwrite-save”, “all-separately-save”, and “part-separately-save”. If the judgment result in STEP S1201 is the uniform judgment, a saving format is selected in accordance with a type of the original electronic document of the document attribute information acquired in STEP S1109 shown in FIG. 9. Also, the judgment result in STEP S1201 is the individual judgment, the saving format selected based on the document-classified management information acquired in STEP S1202 is selected.

Moreover, in the operations of the saving format determination processing shown in FIG. 10 and FIG. 11, and the above-described modification examples of the processing, any one may be determined as a saving format of the added data respectively, from among the saving format selected in STEP S1203, the saving format selected in STEP S1204, and the saving format selected based on the document attribute information, and thereby the operations in STEP S1205 to STEP S1215 may be omitted.

Accordingly, a saving format of important documents to which overwriting might cause a trouble, and circulation documents presupposed to be overwritten, for example, can be uniformly determined in accordance with a type of documents. Also, a saving format of approval documents that need an approval of a specified user can be changed in accordance with a user type.

Moreover, the following may be employed. Judgment is not performed whether the uniform judgment or the individual judgment based on the judgment mode indicated by the document attribute information. Any judgment mode is not defined. In the same way as the above modification examples, in document attribute information, a saving format is defined in accordance with a type of the original electronic document, and the saving format selected based on document-classified management information is compared with the saving format defined in the document attribute information. If the two compared saving formats correspond with each other, the saving format defined in the document attribute information is determined as a saving format of the added data. Also, if the two compared saving formats do not correspond with each other, the saving format selected based on the document-classified management information is determined as a saving format of the added data.

For example, supposed that a saving format in the document attribute information is “overwrite-save”, and a saving format defined in the document management information is “overwrite-save” for a user who belongs to the user type “creator of original electronic document” or “staff authorized to correct original electronic document”.

Also, supposed that a saving format defined in the document management information is “part-separately-save” or “all-separately-save” for a user who does not belong to the above-mentioned user types. Under such supposition, if a user who requests registration of added data belongs to the user type the “creator of original electronic document” or “staff authorized to correct original electronic document”, “overwrite-save” is determined as a saving format of the added data. Also, if the user neither belongs to the user type “creator of original electronic document” nor “staff authorized to correct original electronic document”, “part-separately-save” or “all-separately-save” is determined as a saving format of the added data.

Moreover, in document-classified management information, if “overwrite-save” is defined as a saving format for all the users, “overwrite-save” is uniformly determined as a saving format of added data.

What is claimed is:

1. A document management apparatus that manages saving of an original electronic document and an additional electronic document including the original electronic document and additional information, the document management apparatus comprising:
an acquisition unit operable to acquire the additional electronic document inputted by a user; and
a saving control unit operable to determine a saving format of the additional electronic document based on at least one of an attribute of the user and an attribute of the original electronic document, and save the additional electronic document in the determined saving format.

2. The document management apparatus of claim 1, wherein the saving control unit determines whether the saving format of the additional electronic document is an overwrite-saving format.

3. The document management apparatus of claim 2,.wherein if the determined saving format is the overwrite-saving format, the saving control unit overwrites the original electronic document with the additional electronic document to save the additional electronic document, and if the determined saving format is not the overwrite-saving format, the saving control unit saves a part or all of the additional electronic document in a storage location different from a storage location of the original electronic document.

4. The document management apparatus of claim 3, wherein
the saving control unit includes:
a management information acquisition subunit operable to acquire user management information that indicates whether the saving format of the additional electronic document is the overwrite-saving format for overwriting the original electronic document with the additional electronic document and saving the additional electronic document, or a separately-saving format for saving a part or all of the additional electronic document in a storage location different from the storage location of the original electronic document, the saving format of the additional electronic document being defined with respect to the original electronic document and authorized for a plurality of users each of which belongs to one of a plurality of user types; and
a determination subunit operable to identify, based on the user management information, whether a saving format authorized for a user type to which the user who inputs the additional electronic document belongs is the overwrite-saving format or the separately-saving format, and determine the identified saving format as the saving format of the additional electronic document.

5. The document management apparatus of claim 4, wherein
the plurality of user types include a creator and a non-creator of the original electronic document, and
the user management information indicates that the creator is authorized to use the overwrite-saving format, and the non-creator is authorized to use the separately-saving format.

6. The document management apparatus of claim 4, wherein
the plurality of user types include a creator of the original electronic document, a user authorized to perform correction of the original electronic document, and a user who is neither the creator nor the user authorized to perform the correction, and
the user management information indicates that the creator and the user authorized to perform the correction are authorized to use the overwrite-saving format, and the user who is neither the creator nor the user authorized to perform the correction is authorized to use the separately-saving format.

7. The document management apparatus of claim 3, wherein
the saving control unit includes:
an information acquisition subunit operable to acquire document attribute information and user management information, the document attribute information indicating whether the saving format of the additional electronic document defined based on an attribute of the original electronic document is the overwrite-saving format for overwriting the original electronic document with the additional electronic document and saving the additional electronic document, or a separately-saving format for saving a part or all of the additional electronic document in the storage location different from the storage location of the original electronic document, and the user management information indicating whether a saving format authorized for a plurality of users each of which belongs to one of a plurality of user types is the overwrite-saving format or the separately-saving format; and
a determination subunit operable, by comparing the saving format indicated by the acquired document attribute information and a saving format authorized for a user type to which the user who inputs the additional electronic document belongs in the user management information, to determine the saving format of the additional electronic document.

8. The document management apparatus of claim 7, wherein
the plurality of user types include a creator of the original electronic document, a user authorized to perform correction of the original electronic document, and a user who is neither the creator nor the user authorized to perform the correction,
the user management information indicates that the creator and the user authorized to perform the correction are authorized to use the overwrite-saving format, and the user who is neither the creator nor the user authorized to perform the correction is authorized to use the separately-saving format, and
if the saving format indicated by the document attribute information is the overwrite-saving format and the saving format authorized for the user type to which the user who inputs the additional electronic document belongs is the separately-saving format, the determination subunit determines the separately-saving format as the saving format of the additional electronic document.

9. The document management apparatus of claim 3, wherein
if the determined saving format is not the overwrite-saving format but a part-separately-saving format for saving the part of the additional electronic document in the storage location different from the storage location of the original electronic document, the saving control unit saves the part in correspondence with the original electronic document.

10. The document management apparatus of claim 3, wherein
an extraction unit operable to extract the additional information from the additional electronic document, wherein the part of the additional electronic document is the extracted additional information.

11. The document management apparatus of claim 3, wherein
if the determined saving format is not overwrite save and a part or all of the additional electronic document is saved in a storage location different from the storage location of the original electronic document, the saving control unit saves the part or all in a personal folder in correspondence with an identifier of the user who inputs the additional electronic document.

12. The document management apparatus of claim 1, wherein
the saving control unit includes:
a management information acquisition subunit operable to acquire user management information that indicates, for each user type, whether an authorized saving format of the additional electronic document is an overwrite-saving format for overwriting the original electronic document with the additional electronic document and saving the additional electronic document, or a separately-saving format for saving a part or all of the additional electronic document separately from the original electronic document;
a judgment subunit operable to judge the attribute of the original electronic document; and
a determination subunit operable to, based on the saving format of the additional electronic document authorized for a user type to which the user who inputs the additional electronic document belongs and a result of the judgment by the judgment subunit, determine the overwrite-saving format or the separately-saving format as the saving format of the additional electronic document.

13. The document management apparatus of claim 12, wherein
the document management apparatus manages saving of a plurality of original electronic documents and additional electronic documents to which additional information with respect to each of the plurality of original electronic documents is added,
the user management information is created for each original electronic document managed by the document management apparatus, and
the determination subunit determines the overwrite-saving format or the separately-saving format as the saving format of the additional electronic document, based on the saving format of the additional electronic document authorized for the user type to which the user who inputs the additional electronic document belongs in the user management information created with respect to the original electronic document of the inputted additional electronic document and the result of the judgment by the judgment subunit.

14. The document management apparatus of claim 12, wherein
the judgment subunit includes:
a specific information acquisition subunit operable to acquire resolution specific information that indicates resolution of the original electronic document that is an addition object; and
a resolution judgment subunit operable to judge whether the resolution of the original electronic document that is the addition object is low, depending on whether the resolution indicated by resolution specific information is less than a threshold value, wherein
if the saving format is the overwrite-saving format and the resolution judgment subunit judges affirmatively, the determination subunit determines the separately-saving format as the saving format of the additional electronic document.

15. The document management apparatus of claim 12, including:
an output unit operable to output the original electronic document managed by the document management apparatus in a plurality of outputting formats including a network outputting format; and
a difference extraction unit operable to extract, as additional information, differential data between the additional electronic document and the original electronic document; wherein
the user management information indicates, for each user type, whether an authorized saving format of the original electronic document is the overwrite-saving format, an all-separately-saving format for saving the additional electronic document separately from the original electronic document, or a part-separately-saving format for saving only the extracted additional information separately from the original electronic document, and
the judgment subunit includes:
a creation subunit operable to, each time the original electronic document is outputted, create output specific information for specifying an outputting format of the original electronic document; and
a highest output frequency judgment subunit operable to judge which outputting format is a outputting format having a highest output frequency of the original electronic document, based on the created output specific information, wherein
if the saving format is the part-separately-saving format and the output unit judges affirmatively, the determination subunit determines the all-separately-saving format as the saving format of the additional electronic document.

16. The document management apparatus of claim 12, including
a difference extraction unit operable to extract, as additional information, differential data between the additional electronic document and the original electronic document; wherein
the user management information indicates, for each user type, whether an authorized saving format of the original electronic document is the overwrite-saving format, an all-separately-saving format for saving the additional electronic document separately from the original electronic document, or a part-separately-saving format for saving only the extracted additional information separately from the original electronic document,
the judgment subunit judges whether a data size of the original electronic document is no less than a threshold value, and
if the saving format is the all-separately-saving format and the judgment subunit judges affirmatively, the determination subunit determines the partly-saving format as the saving format of the additional electronic document.

17. The document management apparatus of claim 12, wherein
the original electronic document is inputted to the document management apparatus in a plurality of inputting formats including a fax inputting format,
the judgment subunit judges whether the original electronic document is inputted in the fax inputting format, and
if the determined saving format is the overwrite-saving format and the judgment subunit judges affirmatively, the determination subunit determines the part-separately-saving format as the saving format of the additional electronic document.

18. The document management apparatus of claim 1, wherein
the original electronic document and the additional electronic document are image data read from paper documents.

19. A document management method that manages saving of an original electronic document and an additional electronic document including the original electronic document and additional information, the document management method comprising:
an acquiring step of acquiring the additional electronic document inputted by a user; and
a saving controlling step of determining a saving format of the additional electronic document based on at least one of an attribute of the user and an attribute of the original electronic document, and save the additional electronic document in the determined saving format.

20. A document management program that causes a document management apparatus to execute document management processing, the document management apparatus managing saving of an original electronic document and an additional electronic document including the original electronic document and additional information, the document management processing comprising:
an acquiring step of acquiring the additional electronic document inputted by a user; and
a saving controlling step of determining a saving format of the additional electronic document based on at least one of an attribute of the user and an attribute of the original electronic document, and save the additional electronic document in the determined saving format.
